(19) United States
(12) Patent Application Publication
(10) Pub. No.: US 2008/0137199 A1
(43) Pub. Date: Jun. 12, 2008

(54) Optical plate having three layers and backlight module with same

(75) Inventors: Tung-Ming Hsu, Tu-cheng (TW); Shao-Han Chang, Tu-cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI Precision Industry CO., LTD., Tu-Cheng City (TW)

(21) Appl. No.: 11/716,158

(22) Filed: Mar. 9, 2007

(30) Foreign Application Priority Data
Dec. 6, 2006 (CN) 200610201225.9

(51) Int. Cl. G02B 5/02

(52) U.S. Cl. 359/599; 362/620

(57) ABSTRACT

An exemplary optical plate includes a first transparent layer, a second transparent layer and a light diffusion layer. The light diffusion layer is between the first and second transparent layers. The light diffusion layer, the first and second transparent layers are integrally formed. The light diffusion layer includes a transparent matrix resin and a plurality of diffusion particles dispersed in the transparent matrix resin. The first transparent layer defines a plurality of V-shaped protrusions at an outer surface thereof that is distalmost from the second transparent layer. The second transparent layer defines a plurality of spherical depressions at an outer surface thereof that is distalmost from the first transparent layer. A backlight module using the optical plate is also provided.

### CROSS-REFERENCE TO RELATED APPLICATIONS

This application is related to nine copending U.S. patent applications, which are: application Ser. No. 11/620,951 filed on Jan. 8, 2007, and entitled “OPTICAL PLATE HAVING THREE LAYERS”; application Ser. No. 11/620,958, filed on Jan. 8, 2007, and entitled “OPTICAL PLATE HAVING THREE LAYERS AND MICRO PROTRUSIONS”; application Ser. No. 11/623,302, filed on Jan. 5, 2007, and entitled “OPTICAL PLATE HAVING THREE LAYERS”; application Ser. No. 11/623,303, filed on Jan. 15, 2007, and entitled “OPTICAL PLATE HAVING THREE LAYERS AND BACKLIGHT MODULE WITH SAME”; application Ser. No. 11/627,579, filed on Jan. 26, 2007, and entitled “OPTICAL PLATE HAVING THREE LAYERS”; application Ser. No. [to be advised], Attorney Docket No. US12497, and entitled “OPTICAL PLATE HAVING THREE LAYERS AND BACKLIGHT MODULE WITH SAME”; application serial no. [to be advised], Attorney Docket No. US12515, and entitled “OPTICAL PLATE HAVING THREE LAYERS AND BACKLIGHT MODULE WITH SAME”; application serial no. [to be advised], Attorney Docket No. US12893, and entitled “OPTICAL PLATE HAVING THREE LAYERS AND BACKLIGHT MODULE WITH SAME”; and application serial no. [to be advised], Attorney Docket No. US12896, and entitled “OPTICAL PLATE HAVING THREE LAYERS AND BACKLIGHT MODULE WITH SAME”. In all these copending applications, the inventor is Tung-Ming Hsu et al. All of the copending applications have the same assignee as the present application. The disclosures of the above identified applications are incorporated herein by reference.

### BACKGROUND OF THE INVENTION

1. Field of the Invention

The present invention relates to an optical plate for use in, for example, a backlight module, the backlight module typically being employed in a liquid crystal display (LCD).

2. Discussion of the Related Art

The lightness and slimness of LCD panels make them suitable for use in a wide variety of electronic devices such as personal digital assistants (PDAs), mobile phones, portable personal computers, and other electronic appliances. Liquid crystal is a substance that does not itself emit light. Rather, the liquid crystal relies on receiving light from a light source in order to display images and data. In the case of a typical LCD panel, a backlight module powered by electricity supplies the needed light.

FIG. 7 is an exploded, side cross-sectional view of a typical direct type backlight module 10 employing a typical optical diffusion plate. The backlight module 10 includes a housing 11, a plurality of lamps 12 disposed above a base of the housing 11 for emitting light rays, and a light diffusion plate 13 and a prism sheet 15 stacked on top of the housing 11 in that order. Inside walls of the housing 11 are configured for reflecting certain of the light rays upward. The light diffusion plate 13 includes a plurality of dispersion particles therein. The dispersion particles are configured for scattering the light rays, and thereby enhancing the uniformity of light output from the light diffusion plate 13. This can correct what might otherwise be a narrow viewing angle experienced by a user of a corresponding LCD panel (not shown). The prism sheet 15 includes a plurality of V-shaped structures at a top thereof.

In use, light rays from the lamps 12 enter the prism sheet 15 after being scattered in the light diffusion plate 13. The light rays are refracted and concentrated by the V-shaped structures of the prism sheet 15 so as to increase brightness of light illumination, and finally propagate into the LCD panel (not shown) disposed above the prism sheet 15. The brightness can be improved by the V-shaped structures, but the viewing angle may be narrowed. In addition, even though the light diffusion plate 13 and the prism sheet 15 abut each other, a plurality of air pockets still exists at the boundary between them. When the backlight module 10 is in use, light passes through the air pockets, and some of the light undergoes total reflection at one or another of the interfaces at the air pockets. As a result, the light energy utilization ratio of the backlight module 10 is reduced.

Therefore, a new optical means is desired in order to overcome the above-described shortcomings. A backlight module utilizing such optical plate is also desired.

### SUMMARY

In one aspect, an optical plate includes a first transparent layer, a second transparent layer and a light diffusion layer. The light diffusion layer is between the first and second transparent layers. The light diffusion layer, the first and second transparent layers are integrally formed. The light diffusion layer includes a transparent matrix resin and a plurality of diffusion particles dispersed in the transparent matrix resin. The first transparent layer includes a plurality of V-shaped protrusions at an outer surface thereof that is distalmost from the second transparent layer. The second transparent layer includes a plurality of spherical depressions at an outer surface thereof that is distalmost from the first transparent layer.

Other novel features and advantages will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and backlight module. Moreover, in the drawings, like reference numerals designate corresponding parts throughout the several views, and all the views are schematic.

FIG. 1 is an isometric view of an optical plate in accordance with a first embodiment of the present invention.

FIG. 2 is a side cross-sectional view of the optical plate of FIG. 1, taken along line II-II.

FIG. 3 is an exploded, side cross-sectional view of a direct type backlight module in accordance with a second embodiment of the present invention, the backlight module including the optical plate shown in FIG. 2.

FIG. 4 is a side cross-sectional view of an optical plate in accordance with a third embodiment of the present invention.

FIG. 5 is a side cross-sectional view of an optical plate in accordance with a fourth embodiment of the present invention.

FIG. 6 is a side cross-sectional view of an optical plate in accordance with a fifth embodiment of the present invention.

FIG. 7 is a partly exploded, side cross-sectional view of a conventional backlight module having a light diffusion plate and a prism sheet.

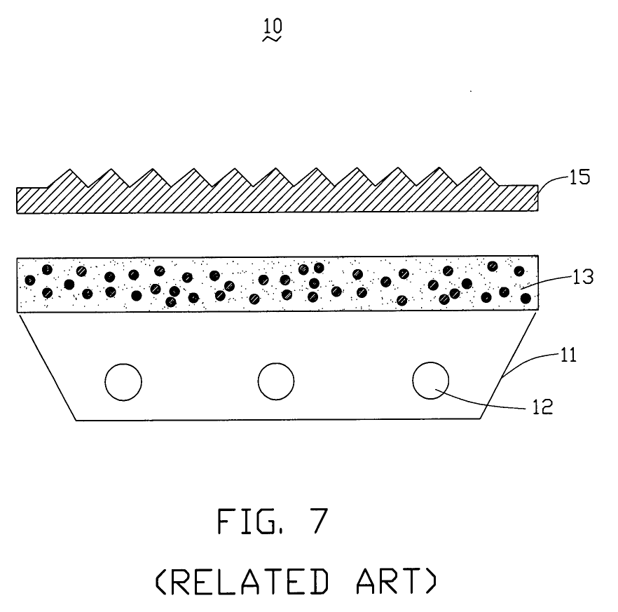

### DETAILED DESCRIPTION OF THE EMBODIMENTS

Reference will now be made to the drawings to describe preferred embodiments of the present optical plate and backlight module, in detail.

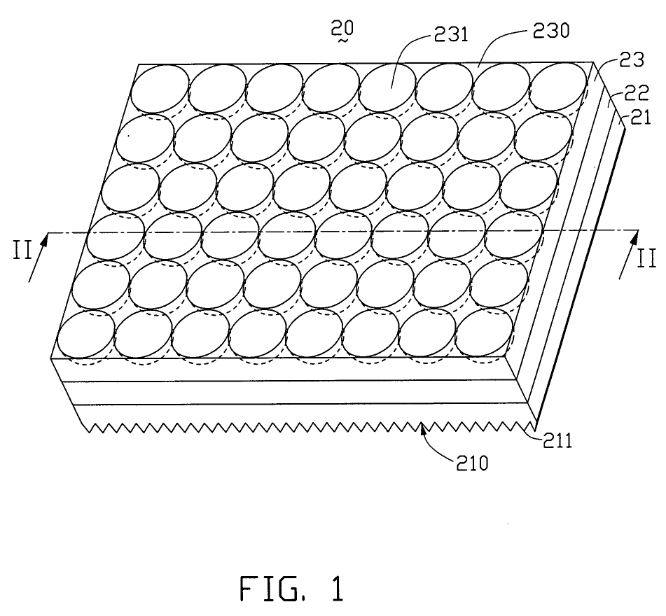

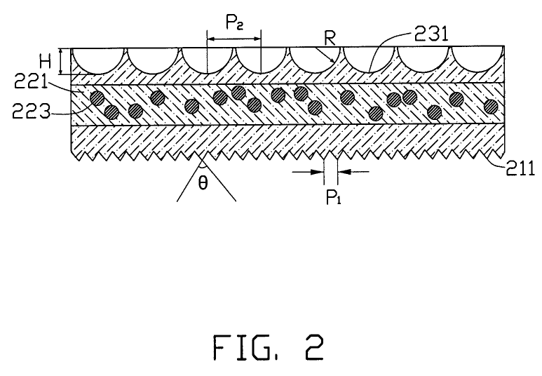

Referring to FIGS. 1 and 2, an optical plate 20 according to a first embodiment of the present invention is shown. The optical plate 20 includes a first transparent layer 21, a light diffusion layer 22, and a second transparent layer 23. The light diffusion layer 22 is between the first and second transparent layers 21, 23. The first transparent layer 21, the light diffusion layer 22, and the second transparent layer 23 can be integrally formed by multi-shot injection molding technology. That is, the first transparent layer 21 and the light diffusion layer 22 are in immediate contact with each other at a first common interface therebetween, and the second transparent layer 23 and the light diffusion layer 22 are in immediate contact with each other at a second common interface therebetween. The first transparent layer 21 includes a plurality of V-shaped protrusions 211 at an outer surface 210 thereof that is distalmost from the second transparent layer 23. The second transparent layer 23 includes a plurality of spherical depressions 231 at an outer surface 230 thereof that is distalmost from the first transparent layer 23.

In the illustrated embodiment, each of the V-shaped protrusions 211 is an elongated ridge that extends along a direction parallel to a side surface of the optical plate 20. The V-shaped protrusions 211 are arranged side by side and parallel to each other at the outer surface 210 of the first transparent layer 21. A pitch P₁ between two adjacent V-shaped protrusions 211 is in the range from about 0.025 millimeters to about 1 millimeter. A vertex angle θ of each V-shaped protrusion 211 is in the range from about 60 degrees to about 120 degrees. In alternative embodiments, each of the V-shaped protrusions 211 can be oriented at an angle relative to the side surface of the optical plate 20.

The spherical depressions 231 are configured for collimating light rays emitting from the optical plate 20, and thereby improving a brightness of light illumination. In the illustrated embodiment, each spherical depression 231 is hemispherical. The spherical depressions 231 are arranged at the light output surface 230 in a matrix, and are separate from one another. In order to achieve high quality optical effects, a radius R of each spherical depression 231 is preferably in a range from about 0.01 millimeters to about 3 millimeters. A maximum depth H of each spherical depression 231 is preferably in the following range: 0.01 millimeters≦H≦R. That is, the depth H is preferably in a range from about 0.01 millimeters to about 3 millimeters. A pitch P₂ between two adjacent spherical depressions 231 is preferably in the following range: R/2≦P₂≦4R. That is, the pitch P₂ is preferably in a range from about 0.005 millimeters to about 12 millimeters. In this embodiment, the depth H is equal to the radius R. and the pitch P₂ is greater than 2R.

A thickness of each of the first transparent layer 21, the light diffusion layer 22, and the second transparent layer 23 can be equal to or greater than 0.35 millimeters. In a preferred embodiment, a combined thickness of the first transparent layer 21, the light diffusion layer 22, and the second transparent layer 23 is in the range from about 1.05 millimeters to about 6 millimeters. Each of the first transparent layer 21 and the second transparent layer 23 is preferably made of one or more transparent matrix resins selected from the group including polyacrylic acid (PAA), polycarbonate (PC), polystyrene (PS), polymethyl methacrylate (PMMA), methylmethacrylate and styrene copolymer (MS), and any suitable combination thereof. It should be pointed out that the materials of the first and second transparent layers 21, 23 can be either the same or different.

The light diffusion layer 22 includes a transparent matrix resin 221, and a plurality of diffusion particles 223 dispersed in the transparent matrix resin 221. The light diffusion layer 22 is configured for enhancing uniformity of light output from the optical plate 20. The transparent matrix resin 221 is selected from the group including polyacrylic acid (PAA), polycarbonate (PC), polystyrene (PS), polymethyl methacrylate (PMMA), methylmethacrylate and styrene copolymer (MS), and any suitable combination thereof. The diffusion particles 223 can be made of material selected from the group consisting of titanium dioxide, silicon dioxide, acrylic resin, and any combination thereof. The diffusion particles 223 are configured for scattering light rays and enhancing a light distribution capability of the light diffusion layer 22. The light diffusion layer 22 preferably has a light transmission ratio in a range from 30% to 98%. The light transmission ratio of the light diffusion layer 22 is determined by a composition of the transparent matrix resin 221 and the diffusion particles 223.

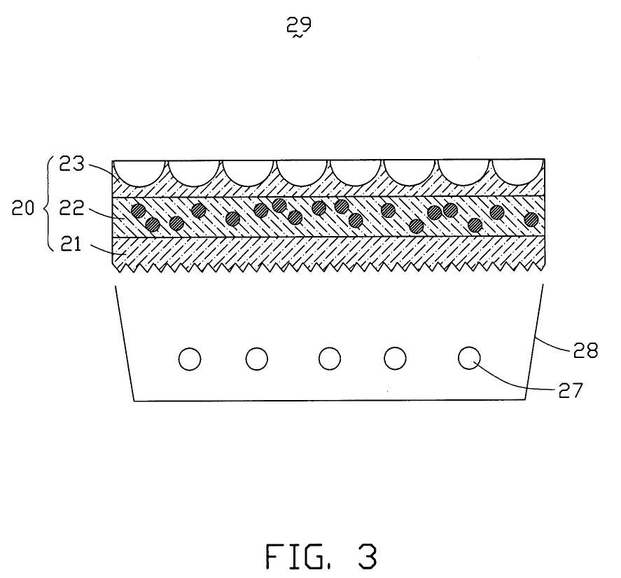

Referring to FIG. 3, a direct type backlight module 29 according to a second embodiment of the present invention is shown. The backlight module 29 includes a housing 28, a plurality of lamp tubes 27, and the optical plate 20. The lamp tubes 27 are regularly arranged above a base of the housing 28. The optical plate 20 is positioned on top of the housing 28, with the first transparent layer 21 facing the lamp tubes 27. It should be pointed out that in an alternative embodiment, the second transparent layer 23 of the optical plate 20 can be arranged to face the lamp tubes 32. That is, light rays from the lamp tubes 27 can enter the optical plate 20 via a selected one of the first transparent layer 21 and the second transparent layer 23.

In the backlight module 29, when light rays enter the optical plate 20 via the first transparent layer 21, the light rays are diffused by the V-shaped protrusions 211 of the first transparent layer 21. Then the light rays are further substantially diffused in the light diffusion layer 22. Finally, many or most of the light rays are condensed by the spherical depressions 231 of the second transparent layer 23 before they exit the optical plate 20. Therefore, a brightness of the backlight module 29 is increased. In addition, the light rays are diffused at two levels, so that a uniformity of light output from the optical plate 20 is enhanced. Furthermore, the first transparent layer 21, the light diffusion layer 22, and the second transparent layer 23 are integrally formed together (see above), with no air or gas pockets trapped in the respective common interfaces therebetween. Thus there is little or no back reflection at the common interfaces, and the efficiency of utilization of light rays is increased. Moreover, the optical plate 20 utilized in the backlight module 29 in effect replaces the conventional combination of a diffusion plate and a prism sheet. Thereby, a process of assembly of the backlight module 29 is simplified, and the efficiency of assembly is improved. Still further, in general, a volume occupied by the optical plate 20 is less than that occupied by the conventional combination of a diffusion plate and a prism sheet. Thereby, a volume of the backlight module 29 is reduced.

In the alternative embodiment, when light rays enter the optical plate 20 via the second transparent layer 23, the uniformity of light output from the optical plate 20 is also enhanced, and the utilization efficiency of light rays is also increased. Nevertheless, the light rays emitted from the optical plate 20 via the first transparent layer 21 are different from the light rays emitted from the optical plate 20 via the second transparent layer 23. For example, when the light rays enter the optical plate 20 via the first transparent layer 21, a viewing angle provided by the backlight module 29 is somewhat larger than that of the backlight module 29 when the light rays enter the optical plate 20 via the second transparent layer 23.

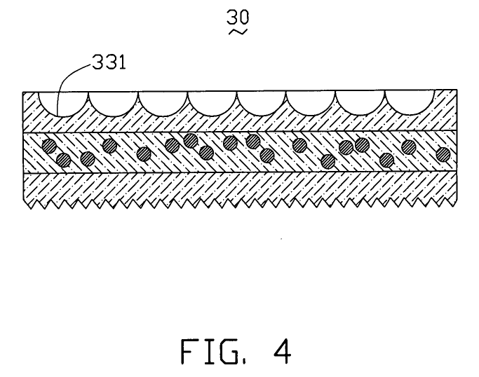

Referring to FIG. 4, an optical plate 30 according to a third embodiment of the present invention is shown. The optical plate 30 is similar in principle to the optical plate 20 of the first embodiment. However, spherical depressions 331 of the optical plate 30 are connected with each other.

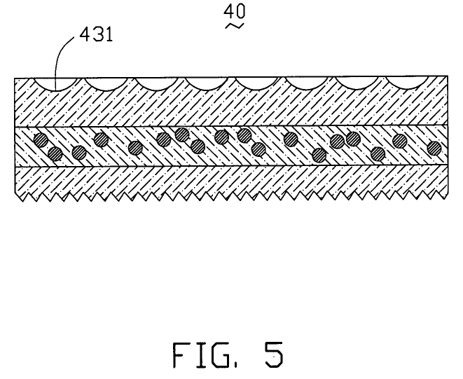

Referring to FIG. 5, an optical plate 40 according to a fourth embodiment of the present invention is shown. The optical plate 40 is similar in principle to the optical plate 20 of the first embodiment. However, in the optical plate 40, each of spherical depressions 431 is sub-hemispherical. In the illustrated embodiment, a maximum depth of each spherical depression 431 is half of a radius R (not shown) of the spherical depression 431.

In the above-described embodiments, the first common interface between the light diffusion layer and the first transparent layer is flat, and the second common interface between the light diffusion layer and the second transparent layer is also flat. Alternatively, either or both of the common interfaces can be nonplanar. For example, either or both of the common interfaces-can be curved or wavy.

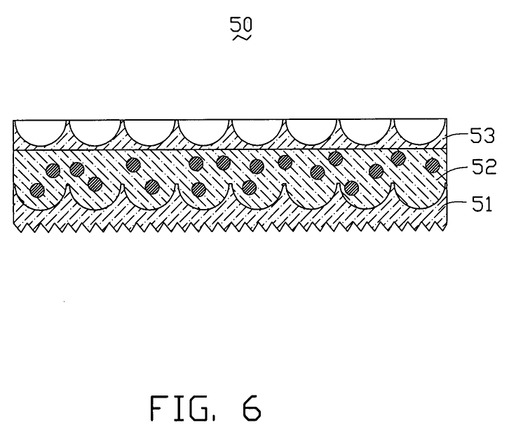

Referring to FIG. 6, an optical plate 50 according to a fifth embodiment of the present invention is shown. The optical plate 50 is similar in principle to the optical plate 20 of the first embodiment. However, the optical plate 50 includes a first transparent layer 51, a light diffusion layer 52, and a second transparent layer 53. A first common interface (not labeled) between the first transparent layer 51 and the light diffusion layer 52 is nonplanar. In the illustrated embodiment, the first common interface is defined by a plurality of protrusions of the light diffusion layer 52 interlocked in a corresponding plurality of depressions of the first transparent layer 51. Therefore, a binding strength between the first transparent layer 51 and the light diffusion layer 52 can be increased. In one kind of further or alternative embodiment, a second common interface between the light diffusion layer 52 and the second transparent layer 53 can be a nonplanar interface.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. An optical plate, comprising:
a first transparent layer;
a second transparent layer; and
a light diffusion layer between the first transparent layer and the second transparent layer, the light diffusion layer including a transparent matrix resin and a plurality of diffusion particles dispersed in the transparent matrix resin, wherein the light diffusion layer and the first and second transparent layers are integrally molded together, with the first transparent layer in immediate contact with the light diffusion layer and the second transparent layer in immediate contact with the light diffusion layer such that there are no air or gas pockets trapped between the first transparent layer and the light diffusion layer nor between the second transparent layer and the light diffusion layer and the first transparent layer has a plurality of V-shaped protrusions at an outer surface thereof that is farthest from the second transparent layer, and the second transparent layer has a plurality of spherical depressions at an outer surface thereof that is farthest from the first transparent layer.

2. The optical plate as claimed in claim 1, wherein a thickness of each of the light diffusion layer, the first transparent layer, and the second transparent layer is equal to or greater than 0.35 millimeters.

3. The optical plate as claimed in claim 2, wherein a combined thickness of the light diffusion layer, the first transparent layer, and the second transparent layer is in the range from about 1.05 millimeters to about 6 millimeters.

4. The optical plate as claimed in claim 1, wherein each of the first transparent layer and the second transparent layer is made of material selected from the group consisting of polyacrylic acid, polycarbonate, polystyrene, polymethyl methacrylate, methylmethacrylate and styrene copolymer, and any combination thereof.

5. The optical plate as claimed in claim 1, wherein a pitch between two adjacent V-shaped protrusions is in the range from about 0.025 millimeters to about 1 millimeter.

6. The optical plate as claimed in claim 5, wherein a vertex angle of each V-shaped protrusion is in the range from about 60 degrees to about 120 degrees.

7. The optical plate as claimed in claim 1, wherein a pitch between two adjacent spherical depressions is in the range from double a radius defined by each of the spherical depressions to four times the radius defined by each of the spherical depressions.

8. The optical plate as claimed in claim 1, wherein the radius of each of the spherical depressions is in the range from about 0.01 millimeters to about 3 millimeters.

9. The optical plate as claimed in claim 1, wherein each of the spherical depressions is sub-hemispherical.

10. The optical plate as claimed in claim 9, wherein a maximum depth of each sub-hemispherical depression is less than a radius of the sub-hemispherical depression.

11. The optical plate as claimed in claim 1, wherein the spherical depressions are arranged regularly at the outer surface of the second transparent layer in a matrix.

12. The optical plate as claimed in claim 11, wherein the spherical depressions are separate from one another.

13. The optical plate as claimed in claim 11, wherein adjacent spherical depressions are connected with each other.

14. The optical plate as claimed in claim 1, wherein at least one of the following interfaces is flat: an interface between the light diffusion layer and the first transparent layer, and an interface between the light diffusion layer and the second transparent layer.

15. The optical plate as claimed in claim 1, wherein at least one of the following interfaces is nonplanar: an interface between the light diffusion layer and the first transparent layer, and an interface between the light diffusion layer and the second transparent layer.

16. The optical plate as claimed in claim 15, wherein at least one of the at least one nonplanar interface is defined by a plurality of protrusions of one of the layers interlocked in a corresponding plurality of depressions of the corresponding adjacent layer.

17. The optical plate as claimed in claim 1, wherein the transparent matrix resin is selected from the group consisting of polyacrylic acid, polycarbonate, polystyrene, polymethyl methacrylate, methylmethacrylate and styrene copolymer, and any combination thereof.

18. The optical plate as claimed in claim 1, wherein a material of the diffusion particles is selected from the group consisting of titanium dioxide, silicon dioxide, acrylic resin, and any combination thereof.

19. A direct type backlight module, comprising:
a housing;
a plurality of light sources disposed on or above a base of the housing; and
an optical plate disposed above the light sources at a top of the housing, the optical plate comprising:
a first transparent layer;
a second transparent layer; and
a light diffusion layer between the first transparent layer and the second transparent layer, the light diffusion layer including a transparent matrix resin and a plurality of diffusion particles dispersed in the transparent matrix resin, wherein the first transparent layer, the light diffusion layer, and the second transparent layer are integrally formed molded together with the first transparent layer in immediate contact with the light diffusion layer and the second transparent layer in immediate contact with the light diffusion layer such that there are no air or gas pockets trapped between the first transparent layer and the light diffusion layer nor between the second transparent layer and the light diffusion layer, and the first transparent layer comprises a plurality of V-shaped protrusions at an outer surface thereof farthest from the second transparent layer, and the second transparent layer comprises a plurality of spherical depressions at an outer surface thereof farthest from the first transparent layer.

20. The direct type backlight module as claimed in claim 19, wherein a selected one of the first transparent layer and the second transparent layer of the optical plate is arranged to face the light sources.
